(19) United States
(12) Patent Application Publication
(10) Pub. No.: US 2003/0105706 A1
(43) Pub. Date: Jun. 5, 2003

(54) Method of performing an auction considering reliability information

(75) Inventor: Klaus Humberto Stanglmayr, Vienna (AT)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/304,117

(22) Filed: Nov. 25, 2002

(30) Foreign Application Priority Data
Nov. 30, 2001 (EP) 01 000 692.2

(51) Int. Cl. G06F 17/60

(52) U.S. Cl. 705/37

(57) ABSTRACT

In the case of an auction by means of an exchange (100), an offeror (20a, 20b, 20c) can transmit offers (AB) with offeror conditions and prospective bidders (20a, 20b, 20c) can transmit bids (GB) with prospective bidder conditions to the exchange (100). From a comparison of the offer with the bid and from an evaluation of stored feedback information a bid is awarded to a prospective bidder selected and a communications connection is established between the offeror and the prospective bidder selected. Thereafter feedback information can be generated and stored both by the offeror and by the prospective bidder selected.

The invention relates to a method of conducting an auction by means of an exchange, in which method an offeror can transmit an offer with offeror conditions and at least one prospective bidder can transmit at least one bid with prospective bidder conditions to the exchange.

The invention further relates to an exchange for conducting an auction, to which exchange an offeror can transmit an offer with offeror conditions and at least one prospective bidder can transmit at least one bid with prospective bidder conditions.

The invention further relates to a computer program product, which is suitable for conducting an auction, an offeror being able to transmit an offer with offeror conditions and at least one prospective bidder being able to transmit at least one bid with prospective bidder conditions.

The invention further relates to a computer, which runs the computer program product according to the previous paragraph.

Patent document U.S. Pat. No. 6,161,099 discloses a system and a method of conducting auctions via an electronic network—in particular via the Internet. In this an auctioneer operates an auction Web page on an auction server, from which auction Web page information can be obtained on an item at auction and auction conditions. A prospective bidder participates in an auction, by accessing the auction Web page by means of a computer connected to the Internet and by means of a conventional Internet browser run on this computer. The prospective bidder or user, who visits the auction Web page of the auctioneer, is guided through a series of Web pages and can prepare and send bids by writing inputs and the use of conventional,,mouse clicks”, as when accessing a typical Web page or Internet page. In order to submit legitimate bids, prospective bidders must register or enroll by filling out a registration-Web page. Registration is necessary, in order to prevent unauthorized persons interfering in the auction or obtaining information thereon. On a bid submission Web page a prospective bidder can prepare, check and amend a bid on a trial basis before he sends it, that is to say before transmitting it to the auctioneer's auction server. A confirmation stage can be performed in order to ensure that the bid is correct before it is sent. When a bid has been sent, it is compared with what is currently the highest bid. If the bid submitted is higher than the currently highest bid, this submitted bid is recorded as the new currently highest bid and, if so desired, is made available to all other prospective bidders. At the end of the auction, that is to say after a fixed period of time has elapsed, the auctioneer's computer or auction server informs the computers of the prospective bidders of the successful bid, that is of the acceptance of the bid.

The known system and the known method of conducting an auction are primarily designed for the auctioning of municipal bonds or the like. One objective of this is to obtain the highest possible bid in the auction time, that is to sell to the highest bidding prospective bidders at the highest possible price.

A serious disadvantage of the known system and method is that an auctioneer is at the mercy of the highest bidding prospective bidder in subsequent handling of the transaction if, for example, the highest bidding prospective bidder allows himself an excessive length of time in paying or transferring the agreed sum, which ultimately has negative implications for the auctioneer. Conversely, the same applies to the highest bidding prospective bidder, if forwarding of the item bought at auction does not occur in the desired form or the required time. In a further auction the same undisciplined auctioneer and the same undisciplined prospective bidder may again reach an agreement possibly with other parties to the auction, which is to the detriment of the party affected by such lack of discipline.

It is an object of the invention to eliminate the difficulties outlined above and to create an improved method of conducting auctions of the generic type initially specified in the first paragraph and an improved exchange of the generic type initially specified in the second paragraph and an improved computer program product of the generic type initially specified in the third paragraph and an improved computer of the generic type initially specified in the fourth paragraph, in which the aforementioned disadvantages are avoided.

The aforementioned object is achieved in such a method according to the invention by the provision of features according to the invention, so that a method according to the invention may be characterized as follows:

A method of conducting an auction by means of an exchange, in which method an offeror can transmit an offer with offeror conditions and at least one prospective bidder can transmit at least one bid with prospective bidder conditions to the exchange, a comparison being made between the offer and at least one bid, in which comparison a comparative result is obtained, and stored feedback information being evaluated, in which evaluation an evaluation result is obtained, and the evaluation result and the comparative result being used to determine at least one prospective bidder and to establish a communications connection between the offeror and at least one prospective bidder selected, and both the offeror and at least one prospective bidder selected being able to generate and store feedback information once the communications connection has been established.

The aforementioned object is achieved in an exchange according to the invention by the provision of features according to the invention, so that an exchange according to the invention may be characterized as follows:

An exchange for conducting an auction having offer recording means for recording an offer with offeror conditions from an offeror and with bid recording means for recording at least one bid with prospective bidder conditions from at least one prospective bidder, and having offer/bid comparison means for comparing the offer with the bids, in which comparison a comparative result is obtained, and having feedback evaluation means for evaluating stored feedback information, in which evaluation an evaluation result is obtained, and having prospective bidder determining means in order to determine at least one prospective bidder by means of the evaluation result and the comparative result, and having auction bid acceptance notification means to establish a communications connection between the offeror and at least one prospective bidder selected, and having feedback information recording means for recording feedback information and having feedback information storage means for storing feedback information.

The aforementioned object is achieved in a computer program product according to the invention by the provision of features according to the invention, so that a computer program product according to the invention may be characterized as follows:

A computer program product which computer program product can be loaded directly into an internal memory of a computer and comprises software code sections characterized in that the computer is capable of operating the method as claimed in claim 1 by means of the computer when the computer program product is run on the computer.

The aforementioned object is achieved in a computer according to the invention by the provision of features according to the invention, so that a computer according to the invention may be characterized as follows:

A computer having a central processing unit and an internal memory, which runs the computer program product as claimed in claim 14.

Providing the features according to the invention is a very simple way of ensuring, at minimal additional cost, that means and/or facilities are provided, for storing reliability information in the form of feedback information relating to a prospective bidder and/or an offeror, that is an auctioneer, and making further use of this after storage. Such reliability information, for example, may relate and give expression to an auctioneer's satisfaction with a highest bidding prospective bidder, already known from at least one earlier auction, concerning the conduct of the transaction following such an earlier auction. At the same time it is of particular advantage in some instances if, for example, the bid is awarded not to the prospective bidder making the highest bid and having poor or unsatisfactory reliability data, but to a prospective bidder making a lower bid, who nevertheless has better reliability data, if this guarantees the auctioneer a swifter processing of the financial transaction following the auction.

The measures as claimed in claim 2 and claim 3 and claim 11 advantageously ensure that account can be taken of a qualification on the part of an offeror or of prospective bidders should an auction transaction materialize, that is to say when it is determined that an offer has been accepted. This is particularly advantageous, for example, where the item at auction is a service, say a translation of a voice data file in digital (electronic) format.

The measures as claimed in claim 4 and claim 13 offer the advantage that although no further actions are necessary on the part of an offeror and/or a prospective bidder the advantages according to the invention still accrue. The said measures are of particular advantage when the auction involves putting services out to tender, such as the conversion of dictated voice data files into text data files and subsequent correction, for example, the conversion being performed by means of a voice recognition device with the facility for the generation of feedback information.

The measures as claimed in claim 5 and claim 6 and claim 12 offer the advantage that the materialization of an auction transaction, that is the acceptance of a bid or the determination of a prospective bidder, is dependent not only on a best offer or highest bid, but also on reliability or the rating of the conduct of a transaction that has already taken place earlier. Repeated participation in such an auction influences the corresponding reliability data of a corresponding participant.

The measures as claimed in claim 7 and claim 8 offer the advantage that an auction can be conducted with particular ease and efficiency. These measures known in the art are particularly advantageous in conjunction with the present invention if an item at auction can be dispatched or transmitted electronically, as with the translation of an electronic voice data file put out to tender, for example.

The measures as claimed in claim 9 advantageously provide ease of use or operation for technically inexperienced users, that is offerors and/or prospective bidders, since all inputs can be effected by speaking or by means of a conversation.

The aforementioned aspects and further aspects of the invention will be apparent from the examples of embodiment described below and are explained with reference to these examples of embodiments.

The invention will be further described with reference to examples of embodiments shown in the drawings to which, however, the invention is not restricted.

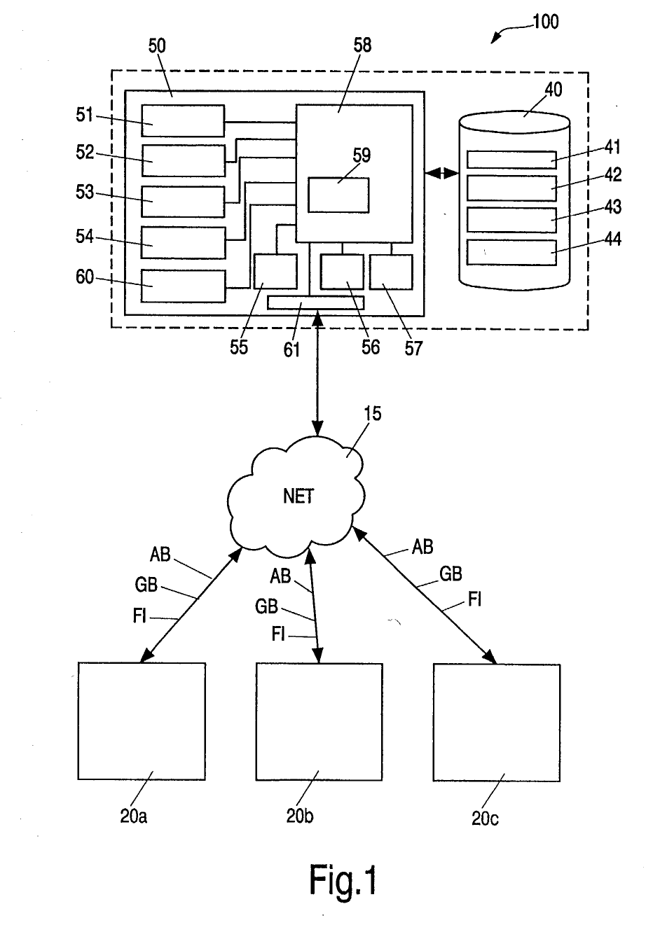

FIG. 1 shows, schematically and in the form of a block diagram, a system of conducting an auction according to an example of an embodiment of the invention.

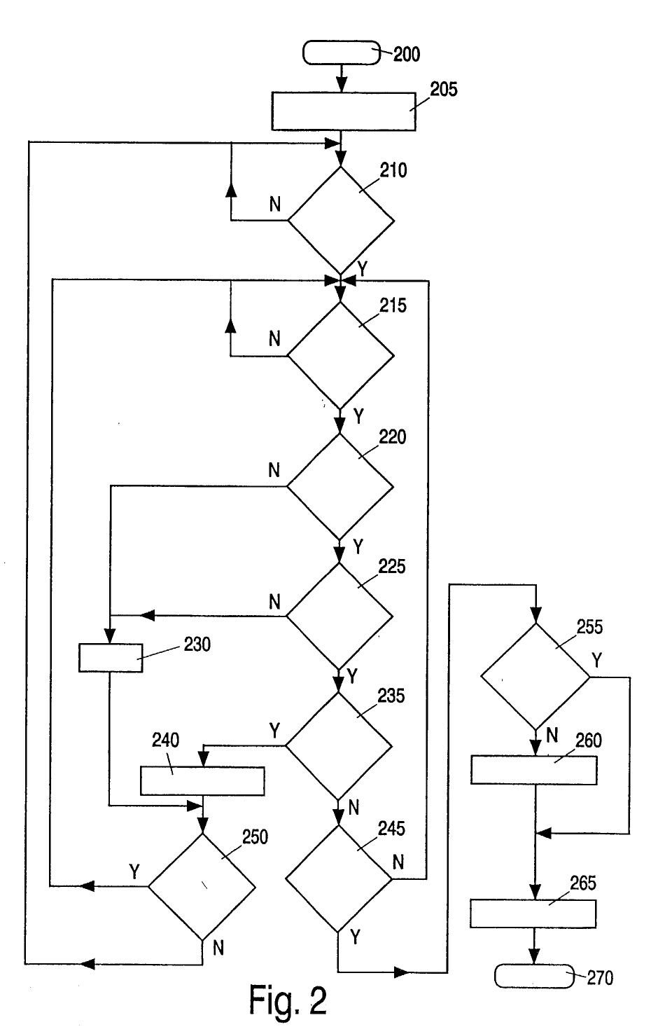

FIG. 2 shows a flow chart, which can be implemented in an exchange according to one example of an embodiment of the invention.

FIG. 1 shows a system for conducting an auction by means of an exchange 100, which exchange 100 is connected to a first user 20a, a second user 20b and a third user 20c via the Internet 15. The users 20a, 20b and 20c are offerors or computers of offerors, who transmit an item at auction with offeror conditions to the exchange 100 for the purpose of an auction or sale by auction, or they are prospective bidders or computers of prospective bidders who wish to acquire an item at auction, that is they wish to conclude an auction transaction, and who in so doing transmit at least one bid with prospective bidder conditions to the exchange, or they are an association of offerors and prospective bidders for an item at auction. It may be mentioned that the number of users is in no way limited to those stated, but may be some multiple thereof, for example one hundred (100) or one thousand (1000) users, depending on any restriction imposed by the Internet 15, by means of which the users are connected. The exchange 100 has a server 50 and a database 40 linked to the server 50, the database 40 having widely varying means of data storage, which will examined in more detail in due course.

The server 50 has a Web interface 61, the Web interface 61 being designed for the communication of data via the Internet 15 and capable of running corresponding communication protocols (for example SMTP, HTTP). Such a Web interface 61 will be familiar to experts, for which reason it will not be examined further here. The Web interface 61 is connected to a system controller 58, the system controller 58 being connected to a series of data processing means and being designed to control these data processing means, which will be examined in more detail in due course.

According to one example of an embodiment of the invention, the system controller 58 is connected to more than one means, that is to offer recording means 56, which are designed to record an offer AB with offeror conditions on the part of each offeror 20a, 20b, 20c, and to bid recording means 57, which are designed to record a bid GB with prospective bidder conditions on the part of each prospective bidder 20a, 20b, 20c, and to user registration means 55, which are designed to register an offeror and/or a prospective bidder, and to time monitoring means 51, which are designed to monitor the expiry of a period of time, and to offer/bid comparison means 52, which are designed to conduct a comparison between an offer AB and at least one bid GB, and to feedback information recording means 60, which are designed to record feedback information FI, and to feedback information evaluation means 53, which are designed to evaluate the feedback information FI. The system controller 58 furthermore has prospective bidder determining means 59, which are designed to determine a prospective bidder who may conclude an auction transaction, that is have their bid accepted. The parties to the auction, that is the offeror and the prospective bidder selected, are informed of the acceptance of the bid by auction bid acceptance notification means 54, connected to the system controller 58 and designed for this purpose.

As mentioned previously, the server 50 is designed, with the aid of the aforementioned means, to process and control the likewise aforementioned data, the data being at least partially storable in the database 40. The database 40 has a plurality of storage means, that is user profile storage means 41, which are designed to store a user profile, and auction data storage means 42, which are designed to store auction data, and feedback information storage means 43, which are designed to store feedback information, and Web page storage means, which are designed to store Web pages, which can be examined by a user.

FIG. 2 in the form of a flow chart represents a sequence of operations running in the exchange 100 according to FIG. 1 and describes a possible sequence of operation in an auction according to the invention. This auction is part of a transcription system, in which transcription system dictated voice data files from an author are converted into text data files by a voice recognition device and amended by correction personnel.

The sequence of operations starts at a block 200. Following on from block 200, an item at auction, that is an offer from one of the offerors 20a, 20b, 20c is put up for auction in a block 205, the offer in this instance being for the translation of dictated voice data files put out to tender and the offeror being the author of the dictated voice data files. The item at auction is offered via the offer registration means 56 by accessing an offer Web page intended for this purpose and stored in the Web page storage means 44. A verification by the offeror, that is a so-called log-on by entering a name and a password may be necessary for authorized use of this offer Web page. If being used by the offeror for the first time, he has the facility to register with the system by means of the user registration means 55, thereby registering the offeror. In such offeror registration, personal and other offeror registration data such as name, address, credit card number etc. are called up by an offeror registration Web page, the offeror-registration data then being stored in the user profile storage means 41. In addition it is also possible to input information on the speech profile of the offeror, information on the speech environment, the voice recognition model used etc. together with default values relating to any time limit by which the translation and the associated corrections are to be completed, and an upper price limit for the offer. The offeror registration may be undertaken by the offeror himself or by a system administrator or supervisor of the exchange. Similar methods of registration or log-on will be sufficiently familiar to experts in the field and for this reason will not be examined further here.

After the offeror or the author of a dictated voice data file has logged on, the said author has the facility to record or compile such a dictated voice data file by means of the offer Web page. For this purpose the offer Web page offers a recorder function using recording means contained in the offer recording means 56, the recorder function including recording, playback, fast forward, rewind, stop and similar functions. The recorded dictated voice data file is stored in the auction data storage means 42. It might be mentioned that a dictated voice data file can also be recorded locally on the computer of each author or offeror 20a, 20b, 20c and the recorded dictated voice data file can then be transmitted to the exchange 100. It might be mentioned that the dictated voice data file can be automatically transmitted on completion of the recording, or transmitted only on a command, for example by operating a command button on the Web page. The recording and transmission of a dictated voice data file via a Web page will be familiar to experts in the field and for this reason will not be examined further.

The offer Web page affords the offeror or author of a dictated voice data file facilities for notifying offeror conditions, that is additional information on the offer, or of automatically resorting to the default values specified in the registration. In the case cited of putting services out to tender, the following might be specified as up-datable offeror conditions: an upper price limit for a price per translated line of 5 cents/line, for example, and/or that the translation must be delivered within a delivery time, say, of two (2) hours, or within twelve (12) hours or within two (2) days. Under further additional information or offeror conditions relating to the offer, the offeror may request, for example, that a prospective bidder undertaking the translation has a certain level of performance.

The dictated speech data file transmitted to the exchange 100 is converted into a text data file by voice recognition means contained in the system controller 58. Among other things, in this conversion process data and information are generated on personal characteristics and qualities of the author of the dictated voice data file, such as information on a quality rating relating to some quality or comprehensibility of the author of the dictated voice data file and/or information relating to a specialized field of the dictated voice data file. It might be mentioned that the said additional information in no way limits the idea of the invention and that it will be very easy for a person skilled in the art to enumerate other factors and information in this regard, for which reason these will not be examined further. Such a method of converting dictated voice data files into text data files in which various additional information is generated, is well known in to the corresponding experts, for which reason it will not be examined further. It might be mentioned that the said personal characteristics and qualities relating to an author can also be inputted or amended by the author or offeror in question via the offer Web page.

Once the dictated voice data file or the offer as described above has been transmitted to the exchange 100 and converted into a text data file, the offer is stored in an auction list or job list, that is put up for auction. The auction list is located on an auction Web page, the auction Web page being stored in the Web page storage means 44. An extract from the auction list is shown in Table 1. An offeror factor specified in Table 1 summarizes the various additional information relating to the offeror that is specified in the registration and the information generated when converting the dictated voice data file into a text data file, and makes it possible or easier for the prospective bidder to categorize the offeror in terms of the criteria important and relevant to him.

TABLE 1
(Auction list)

| Job | Name | Offeror Factor | Delivery time | Price limit |
|---|---|---|---|---|
| 1 | Mr. X | 5 | 2 hours | <10 cents/line |
| 2 | Mr. Y | 7 | 12 hours | <5 cents/line |
| 3 | . . . | . . . | . . . | . . . |

In the further course of the sequence of operations involved in the auction, after block 205, monitoring is performed at block 210 to establish whether a prospective bidder has performed a log-on, that is to say has “logged in”. The log-on or logging in of a prospective bidder is done in a similar way to that already described for the logging-in of the offeror, it being possible here to determine prospective bidder registration data by means of the user registration means 55, it being likewise possible to store the prospective bidder registration data in the user profile storage means 41. In the case of the prospective bidder it may, in this instance of the auctioning of dictated voice data file services, involve correction personnel and the prospective bidder registration data may contain: information on the experience of these correction personnel in this field, a correction time factor indicating how long these correction personnel will take to correct a dictation of a specific length, the number of correction jobs carried out per unit time etc.

If a prospective bidder or correction operative is registered or logged in, at a block 215 it is then examined by reference to block 210, whether the prospective bidder who has logged in has entered a bid. A bid is entered via the bid registration means 57 by accessing a bid Web page provided for this purpose and stored in the Web page storage means 44. The bid Web page is only brought up if the prospective bidder who has logged in has previously seen the offer from the offeror in the auction list on the auction Web page, in response to which offer he can make a bid. It might be mentioned that only the offers relevant to him are displayed for the prospective bidder who has logged in. According to the offer, the bid may contain a price, for example two (2) cents per line, and/or the time taken to complete the service or a delivery time.

After entering the bid, after block 215 it is examined at a block 220 by means of the feedback information evaluation means 53 and the feedback information stored in the feedback information storage means 43 and the registration data stored in the user profile storage means 41, whether the prospective bidder entering the bid has the qualifications or characteristics required by the offeror. In the event of a negative outcome (N) to this decision inquiry in block 220, the sequence jumps to a block 230. Otherwise it continues at a block 225. In block 230 the prospective bidder making a bid is informed that his qualifications are inadequate, following which the sequence continues at a block 250. In block 250 the prospective bidder making a bid is offered the opportunity of entering a new bid or discontinuing the bid and logging off and exiting the system. Accordingly, if the wish to enter a new bid (Y) is expressed, the sequence of operations continues at block 215. Otherwise it continues at block 210, where a new logging in procedure must be performed.

At block 225, a check is performed by means of the offer/bid comparison means 52 to see that the bid does not exceed the upper price limit. In the event of a negative outcome (N) to this decision inquiry at block 225, that is if the bid exceeds the upper price limit of the offer, the sequence jumps to block 230. Otherwise it continues at a block 235. At block 230, as already described above, the prospective bidder or bidder is informed that his bid cannot be accepted, following which the sequence of operations resumes at block 250 in the manner already described. At block 235 a check is performed to see whether the price quoted in the present bid is less than the price of an existing best bid for this offer. In the event of positive outcome (Y) to this decision inquiry at block 235 the sequence jumps to block 240. Otherwise it continues at a block 245. At block 240 the current bid is stored as new best bid, following which the sequence continues at block 250 in the manner already described.

By means of the time monitoring means 51 it is examined at block 245 whether an auction time limit AZL or a predetermined auction time span has expired. In the event of a positive outcome (Y) to this decision inquiry at block 245, the sequence jumps to a block 255. Otherwise it continues at block 215. The auction time limit AZL may depend, for example, on the stipulated delivery time, a dictation time and the correction time factor already mentioned, as follows:

AZL=delivery time−dictation time×correction time factor.

For example, a delivery time of one hundred and twenty (120) minutes is stipulated. The dictation time is four (4) minutes, for example, and the correction time factor is assumed to be five (5) minutes, for example. From this the auction time limit AZL of one hundred (100) minutes is arrived at. It might be mentioned that the auction time limit AZL varies only as a percentage of the delivery time, for example 30% or 40% of the delivery time.

With the aid of the prospective bidder determining means 59 it is examined at block 255 whether a best bid is stored or extant. In the event of a positive outcome (Y) to this decision inquiry at block 255, the sequence jumps to a block 265. Otherwise it continues at a block 260. At block 265 the auction bid acceptance notification means 54 inform the prospective bidder making the best bid and fulfilling the offeror's criteria, that is the prospective bidder selected, of the acceptance of the bid in the form of an electronic message (e-mail) whilst at the same time transmitting the offered dictated voice data file and the associated text data file to him or his computer. The prospective bidder selected, who as already stated is in this instance a correction operative, can now perform his service by undertaking a correction of the transmitted text data file. In such a correction procedure correction efficiency data such as the duration of the correction process or number of corrected words and much more can be determined and recorded or stored. Such a correction procedure will be familiar to experts in the field and for this reason will not be examined further here.

After correction of the text data file this corrected text data file is returned together with the correction efficiency data to the exchange 100 and in due course is made available to the relevant author or person putting the service out to tender. The feedback information registration means 60 examine whether the corrected text data file was transmitted on time, that is within the stipulated delivery time. This information is used, together with the correction efficiency data, to update the prospective bidder registration data of the relevant prospective bidder stored in the user profile storage means 41. On the other hand the prospective bidder in question has the facility for updating the offeror registration data which are stored in the user profile storage means 41 and which determine the offeror factor, that is of entering feedback information. Such updating can be undertaken, for example, via a feedback input Web page with appropriate input fields.

Following transmission to the exchange 100 as described above, the corrected text data file is sent to the author or offeror by e-mail, thereby completing this auction transaction. On receipt of the corrected text data file the author or offeror may make a complaint regarding quality, for example the number of typing mistakes, grammatical errors or formatting of text passages in this corrected text data file. In this case the corresponding prospective bidder registration data of the prospective bidder in question or prospective bidder feedback information data stored in the feedback information storage means 43 are updated via the feedback input Web page.

The amendment of registration data or feedback information data, relevant to the determination of bid acceptance, which these means facilitate, over time produces a constantly improved rating of the reliability or qualification of the offerors or prospective bidders, which reliability or qualification is taken into account in determining bid acceptance, with ultimately positive or advantageous effects for the parties to the auction transaction.

It may be observed that the users, that is the offerors and/or prospective bidders, can transmit offers and/or bids by means of the Internet. In this example of an embodiment, for example, the author or offeror could input dictated voice data files by means of a microphone and via the Internet 15. The offeror can register by means of a bar code reader incorporated in the microphone, as is the case, for example, with a Philips Speech-Mike microphone. Another possible way of registering is through speech or voice recognition, which may form an integral part of the system controllers 58.

It may be observed that the sequence of operations represented in FIG. 2 and described above can also fulfill the idea of the invention in modified form or sequence order, as the person skilled in the art will readily appreciate, for example the order of blocks 220 and 225 could be reversed.

It may be observed that a system according to the invention can also be designed to interact with a private or public telephone network, this system having a structure very similar to that represented in FIG. 1, the Web interface 61 additionally having a telephone network interface and the user registration means 55 being additionally designed for registration by means of the telephone network. Such a system is of particular advantage to those users who have no available access to the Internet 15. This allows such a user, for example, to a log in to the exchange 100 via a telephone connected to the telephone network by entering a digital code via the telephone keypad.

It may be observed that with a system for conducting an auction according to the invention a large number of possibilities exist regarding the offer or item at auction. Such offers might relate, for example, to: vehicles, clocks and watches, entertainment electronics products, computers, peripherals, spare parts, houses, real estate, books, antiques, musical instruments, games, sports equipment, stocks, bonds and much more. In addition to the tendering of services, already mentioned, for the translation or conversion of a dictated voice data file, other services tendered can also be auctioned, such as cleaning services, household services, snow clearing services, escort and hostess services, teaching services, consultancy services, reminder services, price comparison services, missing persons tracing services, financial services, information technology services, purchasing services, logistics services, advertising services, computer services, image processing services, servicing services and craft services to name but a few.

Obviously more than one auction can be conducted at once using a facility suitably designed for this purpose, for example in a time division multiplex mode.

With a system according to the invention it is also relatively easy to award a suitable auction offer to more than one prospective bidder, divided up into sub-offers shared between these prospective bidders.

1. A method of conducting an auction by means of an exchange (100), in which method an offeror can transmit an offer (AB) with offeror conditions and at least one prospective bidder can transmit at least one bid (GB) with prospective bidder conditions to the exchange (100), a comparison being made between the offer (AB) and at least one bid (GB), in which comparison a comparative result is obtained, and stored feedback information (FI) being evaluated, in which evaluation an evaluation result is obtained, and the evaluation result and the comparative result being used to determine at least one prospective bidder and to establish a communications connection between the offeror and at least one prospective bidder selected, and both the offeror and at least one prospective bidder selected, being able to generate and store feedback information (FI) once the communications connection has been established.

2. A method as claimed in claim 1, characterized in that the offeror conditions additionally contain characteristics of an offeror.

3. A method as claimed in claim 1, characterized in that the prospective bidder conditions additionally contain characteristics of a prospective bidder.

4. A method as claimed in claim 1, characterized in that the feedback information (FI) is automatically generated and stored, at least in part, by the exchange.

5. A method as claimed in claim 2 or 3, characterized in that an evaluation of the reliability of the recorded offeror conditions or prospective bidder conditions is given as feedback information (FI).

6. A method as claimed in claim 2 or 3, characterized in that an evaluation of the offeror's conduct of a transaction with a prospective bidder selected is given as feedback information (FI).

7. A method as claimed in claim 1, characterized in that the communications connection is established by e-mail.

8. A method as claimed in claim 1, characterized in that the offer (AB) with offeror conditions and/or the bids (GB) with prospective bidder conditions can be transmitted via the Internet and an HTML-page of the exchange.

9. A method as claimed in claim 1, characterized in that the offer (AB) with offeror conditions and/or the bids (GB) with prospective bidder conditions can be transmitted to the exchange via a telephone network.

10. An exchange (100) for conducting an auction having offer recording means (56) for recording an offer (AB) with offeror conditions from an offeror and with bid recording means for recording at least one bid (GB) with prospective bidder conditions from at last one prospective bidder, and
having offer/bid-comparison means (52) for comparing the offer (AB) with the bids (GB), in which comparison a comparative result is obtained, and
having feedback evaluation means (53) for evaluating stored feedback information (FI), in which evaluation an evaluation result is obtained, and
having prospective bidder determining means (59) in order to determine at least one prospective bidder by means of the evaluation result and the comparative result, and
having auction bid acceptance notification means (54) to establish a communications connection between the offeror and at least one prospective bidder selected, and
having feedback information recording means (60) for recording feedback information (FI) and having feedback information storage means (43) for storing feedback information (FI).

11. An exchange as claimed in claim 10, characterized in that additional means are provided for recording characteristics of an offeror and/or prospective bidders.

12. An exchange as claimed in claim 10, characterized in that registration means are provided for recording and storage of an evaluation of the reliability of the recorded data as feedback information (FI) of the offeror and/or of a prospective bidder selected.

13. An exchange as claimed in claim 10, characterized in that means are provided for at least partially operating a tendered service, which means can be used, at least in part, to automatically generate and store feedback information (FI).

14. A computer program product, which computer program product can be loaded directly into an internal memory of a computer and comprises software code sections, characterized in that the computer is capable of operating the method as claimed in claim 1, when the computer program product is run on the computer.

15. A computer program product as claimed in claim 14, characterized in that is stored on computer-readable medium.

16. A computer having a central processing unit and an internal memory, which runs the computer program product as claimed in claim 14.
